(19) United States
(12) Patent Application Publication
(10) Pub. No.: US 2014/0073607 A1
(43) Pub. Date: Mar. 13, 2014

(54) COMPOUNDS FOR USE IN THE TREATMENT OF FELINE RETROVIRAL INFECTIONS

(71) Applicants: Nina Justa, Munich (DE); Katrin Hartmann, Munich (DE); Sylvie Daminet, Denderwindeke (BE); Mariella Debille, Rupelmonde (BE); Joeri Auwerx, Bierbeek (BE); Nesya Goris, Leuven (BE); Stefaan Wera, Bierbeek (BE); Erwin Blomsma, Linden (BE); Aino Billiet, Leuven (BE); Jan Swinnen, Linter (BE); Bert Vrancx, Booischot (BE); Veerle Debeurme, Kessel-lo (BE); Johan Neyts, Kessel-lo (BE)

(72) Inventors: Nina Justa, Munich (DE); Katrin Hartmann, Munich (DE); Sylvie Daminet, Denderwindeke (BE); Mariella Debille, Rupelmonde (BE); Joeri Auwerx, Bierbeek (BE); Nesya Goris, Leuven (BE); Stefaan Wera, Bierbeek (BE); Erwin Blomsma, Linden (BE); Aino Billiet, Leuven (BE); Jan Swinnen, Linter (BE); Bert Vrancx, Booischot (BE); Veerle Debeurme, Kessel-lo (BE); Johan Neyts, Kessel-lo (BE)

(73) Assignee: OKAPI SCIENCES NV, Heverlee (BE)

(21) Appl. No.: 14/110,682

(22) PCT Filed: May 10, 2011
(86) PCT No.: PCT/EP11/57519

§ 371 Date: Oct. 8, 2013

(51) Int. Cl. C07F 9/6558

(52) U.S. Cl. CPC C07F 9/65583
USPC 514/81

(57) ABSTRACT

The present invention relates to compounds and compositions for use in the treatment or prevention of retroviral infections in felines, in particular cats, and to the use of said derivatives for the manufacture of a medicament for the treatment or prevention of feline leukemia virus (FeLV) infections occurring alone or together with feline immunodeficiency virus (FIV) infections in cats.

### FIELD OF THE INVENTION

The present invention relates to compounds and compositions for use in the treatment or prevention of retroviral infections in felines, in particular cats, and to the use of said derivatives for the manufacture of a medicament for the treatment or prevention of feline leukemia virus (FeLV) infections occurring alone or together with feline immunodeficiency virus (FIV) infections in cats.

### BACKGROUND OF THE INVENTION

Feline immunodeficiency virus (FIV) and feline leukemia (FeLV) infections are widely spread: more than 8% of all domestic cats (Felis catus) are HIV infected and up to 14% are FeLV infected (Table 1). Cats are one of the most popular and widespread pet animals; there are more than 400 million domestic cats in the world with Europe and the US as the most dominant regions.

TABLE 1
Prevalence of FIV (Courchamp, 1996) and FeLV

| Infection | FIV | FeLV |
|---|---|---|
| North America | 8.1% | n.a. |
| Oceania | 23.3% | n.a. |
| Asia | >20% | n.a. |
| Europe | 12.7% | n.a. |
| World | 11.0% | 14.2% |

FIV infection is among the most common viral infectious diseases of domestic cats (Felis catus) and has a worldwide prevalence which has been unaltered since it was first discovered in 1986. Testing for FIV is not common and a vaccine against FIV was not introduced until 2002. The vaccine's efficacy is controversial. Moreover, it is not authorized for use in the EU. FIV is also endemic in other free-ranging felids, but infection here does not lead to the development of AIDS-like disease. Nevertheless immune suppression may still occur. In contrast, FIV infection in domestic cats results in disease progression and outcome similar to that of human immunodeficiency virus (HIV) infection in man (Bendinelli et al., 1995). Sick adult cats, tomcats and free roaming cats are most likely to be infected. The major route of natural transmission is via biting (Yamamoto et al., 1989). Vertical transmission and transmission between cats in a stable household is relatively uncommon. Transmission from queen to kittens may, however, occur (Hosie et al., 2009).

Attempts have been made to define the clinical course of FIV infection in different stages analogous to those of HIV infection in man. In cats, staging in only four phases makes more sense because the two different stages of persistent generalized lymphadenopathy (PGL), also termed lymphadenopathy syndrome (LAS), and the AIDS-related complex (ARC) in humans are rarely distinguished in cats (Hartmann, 1998). The classification of FIV infection in four stages is shown in Table 2.

TABLE 2
Classification of FIV infection in four stages (Hartmann, 1998)

| Stage | Phase | | Clinical signs | Duration |
|---|---|---|---|---|
| 1 | Acute | Initial | Neutropenia | Weeks to |
| | phase | stage | Lymphadenopathy | months |
| | | | Fever | |
| 2 | Asymp- | Asymp- | No clinical signs | Years |
| | tomatic | tomatic | | |
| | phase | carrier | | |
| 3 | Phase of | PGL/LAS + | generalized | Months to |
| | unspecific | ARC | lymphadenopathy, recurrent | 1 year |
| | clinical | | fever, apathy, leucopenia, | |
| | signs | | anaemia, anorexia, weight | |
| | | | loss, chronic stomatitis, | |
| | | | behavioral abnormalities | |
| 4 | Terminal | AIDS | ARC symptoms and | Several |
| | AIDS-like | | opportunistic infections, | months |
| | phase | | neoplasie, neurological | |
| | | | abnormalities | |

Most antiviral drugs that are occasionally used in cats to treat FIV infection are licensed for human use (so-called ‘cascade use’) and more specifically for the treatment of HIV. Most of these drugs are toxic to cats or ineffective:
AZT (3′-azido-2′,3′-dideoxythymidine or Zidovudine): common side-effect in cats is non-regenerative anemia. Cats with bone-marrow suppression should not be treated. AZT-resistant mutants of FIV can arise as early as six months after initiation of treatment. The efficacy of AZT for FIV treatment is very limited.
Human interferon-alpha becomes ineffective against FIV after three to seven weeks due to the development of neutralizing antibodies against the human interferon-alpha.
Feline interferon-omega (Virbagen Omega®, VIRBAC) is well tolerated in cats and is active against FIV in vitro but so far only one study has been performed in field cats that did not show significant changes in survival rate when compared to a placebo group (de Man et al., 2004).
   Feline leukemia virus (FeLV) is a gammaretrovirus responsible for many deaths among cats. The virus affects domestic cats and occurs in some wild feline species as well, e.g. including Felis silvestris, and European and Iberian lynxes. There are three main types of feline leukemia virus: FeLV-A, FeLV-B, and FeLV-C. FeLV-positive cats can be infected with one, two, or all three types:
FeLV-A causes severe immunosuppression.
FeLV-B causes more neoplastic disease (i.e. tumors and other abnormal tissue growths) than cats infected only with FeLV-A.
FeLV-C causes severe anemia.
   After the initial infection, the virus replicates in the tonsils and pharyngeal lymph nodes, after which it spreads via the bloodstream to other parts of the body, especially the lymph nodes, bone marrow, and intestinal tissue, where it continues to replicate. Viremia usually shows up 2 to 4 weeks after the initial infection. A cure is not available; treatment is limited to limiting pain and discomfort.

In some European countries, the USA and Canada, the prevalence of FeLV infection in individually-kept cats seems to be less than 1%. However, in large multi-cat households without specific preventive measures for introduction of FeLV, the prevalence may be greater than 20% (Lutz et al., 2009).

Treatment of FeLV-induced viremia with feline interferon omega (interferon-ω) was shown to significantly improve clinical signs and to extend the survival time of FeLV-viremic cats, although it did not lead to reversion of viremia (de Man et al., 2004). No viral parameters, however, were measured throughout the study to support the hypothesis that the interferon actually had an anti-FeLV effect rather than inhibited secondary infections, and further studies are deemed necessary.

A number of FeLV vaccines are now available in Europe. Given that FeLV is (like FIV) a retrovirus, it is not surprising that no FeLV vaccine is likely to provide 100% efficacy of protection and none prevent infection (Hofmann-Lehmann et al., 2007). Recent studies have demonstrated that, without exception, cats that are able to overcome p27 antigenaemia become provirus positive in the blood and also positive for viral RNA in plasma, although at very low levels as compared with persistently viremic cats (Hofmann-Lehmann et al., 2007). These experiments confirm that FeLV vaccination neither induces sterile immunity nor protects from infection.

It has previously been shown that resolved enantiomeres of 2-phosphonomethoxypropyl, 2-phosphonomethoxyethyl and 3-fluoro-2-phosphonomethoxypropyl derivatives of purine and pyrimidine bases are active against retroviruses. Particularly the activity of 9-[2-(phosphono-methoxy)propyl]adenine (PMPA) against human immunodeficiency virus (HIV) has been demonstrated and formulations of the compound are marketed as Tenofovir for treatment of HIV (trade name Viread®).

An improved therapy against retroviral infections in cats would be of high importance in order to treat felines that suffer from FeLV, FIV or both in an efficient and cost-effective way.

### SUMMARY OF THE INVENTION

The present invention relates to the use of derivatives of purine and pyrimidine in the treatment of feline viral diseases.

Indeed, it was surprisingly found that some derivatives of purine and pyrimidine, and more particularly resolved enantiomeres of 2-phosphonomethoxypropyl, 2-phosphonomethoxyethyl and 3-fluoro-2-phosphonomethoxypropyl derivatives of purine and pyrimidine bases are highly active against Feline Leukemia Virus infections (FeLV-infections) and Feline Immunodeficiency Virus. More particularly, it was found that the compounds of the invention reduce viral load of cats infected with either FeLV, FIV or both, and are capable of alleviating clinical symptoms associated with these infections.

Thus, one aspect of the invention relates to compounds for use in the prevention and treatment of a feline infected with feline leukemia virus. The compounds are of the formula (I):

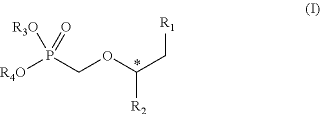

(or a solvate, veterinary acceptable salt, metabolite or prodrug thereof), wherein “*” indicates a stereogenic center; R₁ is adenine, cytosine or 2,6-diaminopurine; R₂ is methyl or monofluoromethyl, provided that R₂ is not methyl when R₁ is adenine; and R₃ and R₄ are hydrogen.

In particular embodiments, the compounds for use in the prevention and treatment of a feline infected with feline leukemia virus according to the present invention are stereoisomerically pure compounds of the formula (Ia):

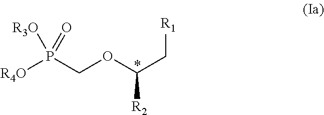

In particular embodiments, the compound for use in the prevention and treatment of a feline infected with feline leukemia virus according to the present invention, (or solvates, veterinary acceptable salts, metabolites or prodrugs thereof), are for use in the prevention and treatment of a feline infected with feline leukemia virus, wherein the feline is co-infected with other retroviruses, such as feline immune deficiency virus.

In specific embodiments, the compound for use in the prevention and treatment of a feline infected with feline leukemia virus according to the present invention, (or a solvate, veterinary acceptable salt, metabolite or prodrug thereof), is a compound according to formula (I) or (Ia), wherein R₁ is 2,6-diaminopurine and R₂ is methyl.

In another specific embodiment, the compound for use in the prevention and treatment of a feline infected with feline leukemia virus according to the present invention, (or a solvate, veterinary acceptable salt, metabolite or prodrug thereof), is a compound according to formula (I) or (Ia), wherein R₁ is adenine and R₂ is monofluoromethyl.

In particular embodiments, the feline with FeLV is suffering from clinical symptoms of FeLV. Particularly, these clinical symptoms are selected from the group consisting of stomatitis, gingivitis, inflammation of the oral cavity, tumors, diarrhea, neurological symptoms, lethargy, weight loss and lymphadenopathy. In certain embodiments, the treatment with the compounds of the present invention involves alleviating one or more clinical symptoms of FeLV. In certain embodiments, the compounds of the present invention are envisaged for increasing the Karnofsky's score modified for cats (see Example 2) with at least 10 units, preferably at least 15 units, and even more preferably at least 20 units, compared to the cat's score prior to treatment.

Another aspect of the invention relates to compounds for use in the treatment of one or more clinical symptoms in a feline infected with FIV. The compounds are of the formula (I), (or a solvate, veterinary acceptable salt, metabolite or a prodrug thereof), wherein R₁ is 2,6-diaminopurine; R₂ is methyl or monofluoromethyl, and R₃ and R₄ are hydrogen. In particular embodiments, these compounds are stereoisomerically pure compounds of the formula (Ia).

In certain embodiments, the one or more clinical symptoms in a feline infected with FIV are selected from the group consisting of loss of body weight, malaise, lethargy, poor coat condition, pyrexia, anemia, concurrent infections, gastroenteritis, gingivitis, neutrophenia, fever, leucopenia, anorexia, neoplasie, stomatitis, gingivostomatitis, rhinitis, diarrhea, chronic or frequent infections of the skin, eyes, urinary tract, respiratory tract, lymphadenopathy, glomerulonephritis, haemorrhagic enteritis, diseases of the nervous system which may cause behavioral changes or seizures, abortion of litters and cancer.

In specific embodiments, the compounds for use in the treatment of one or more clinical symptoms in a feline infected with FIV are compounds of formula (I) or (Ia) (or a solvate, veterinary acceptable salt, metabolite or a prodrug thereof), wherein R₁ is 2,6-diaminopurine and R₂ is methyl.

A further aspect of the invention relates to compounds for use in the treatment of one or more symptoms in a feline infected with Feline immunodeficiency virus or Feline leukemia virus, or in a feline co-infected with Feline immunodeficiency virus and Feline leukemia virus. The compounds according to this aspect of the invention are compound of formula (I) or (Ia) (or a solvate, veterinary acceptable salt, metabolite or a prodrug thereof), wherein R₁ is pyrimidine, purine, 2,6-diaminopurine, 2-aminopurine, cytosine, guanine or an aza or deaza analog thereof; R₂ is hydrogen, methyl or monofluoromethyl, and R₃ and R₄ are hydrogen. The symptoms according to this aspect of the invention are selected from the group consisting of poor appetite, loss of body weight, neutrophenia, fever, leucopenia, anorexia, neoplasie, malaise, apathy, poor coat condition, pyrexia, anemia, concurrent infections, gastroenteritis, gingivitis, stomatitis, gingivostomatitis, rhinitis, diarrhea, chronic or frequent infections of the skin, eyes, urinary tract, respiratory tract, lymphosarcoma, difficult breathing, general inflammation of the oral cavity, diarrhea, lymphadenopathy, pale mucous membranes, gastrointestinal disorders, glomerulonephritis, haemorrhagic enteritis, diseases of the nervous system which may cause behavioral changes or seizures, abortion of litters, tumours and cancer.

In particular embodiments, the compounds (or a solvate, veterinary acceptable salt, metabolite or a prodrug thereof) for use in the treatment of one or more symptoms in a feline infected with Feline immunodeficiency virus and/or Feline leukemia virus are compounds of formula (I) or (Ia) wherein R₁ is 2,6-diaminopurine, 2-aminopurine, cytosine, guanine or an aza or deaza analog thereof. In further particular embodiments, R₁ is diaminopurine. In specific embodiments, R₂ is methyl.

In particular embodiments, the prodrugs according to the various aspects of the present invention are compounds of formula (I) or (Ia) wherein R₃ and R₄ are, the same or different from each other, CH₂C(O)N(R₅)₂, CH₂C(O)OR₅, CH₂OC(O)R₅, CH(R₅)OC(O)R₅ (R, S, or RS stereochemistry), CH₂C(R₅)₂CH₂OH, or CH₂OR₅; and R₅ is C₁-C₂₀ alkyl, aryl or aryl-alkyl which is unsubstituted or is substituted by hydroxy, oxygen, nitrogen or halogen.

In particular embodiments, the compounds for use according to the various aspects of the present invention are administered to a feline at least 1 time weekly with a total dose of 10-175 mg/kg, during 1 to 6 weeks. In further embodiments, the compounds are administered via subcutaneous injections.

### BRIEF DESCRIPTION OF THE DRAWINGS

The following description of the figures of specific embodiments of the invention is merely exemplary in nature and is not intended to limit the present teachings, their application or uses.

FIG. 1A, B, C: Graphs representing the viral load (number of FIV virions per mL plasma—Y axis) pre and post treatment with R-PMPDAP in three different cats.

FIG. 2 Graph representing the viral load (number of FIV and FeLV virions per mL plasma—Y axis) pre and post treatment with R-PMPDAP in a cat co-infected with FIV and FeLV.

### DETAILED DESCRIPTION OF THE INVENTION

The present invention will be described with respect to particular embodiments but the invention is not limited thereto but only by the claims. Any reference signs in the claims shall not be construed as limiting the scope thereof.

As used herein, the singular forms “a”, “an”, and “the” include both singular and plural referents unless the context clearly dictates otherwise.

The terms “comprising”, “comprises” and “comprised of” as used herein are synonymous with “including”, “includes” or “containing”, “contains”, and are inclusive or open-ended and do not exclude additional, non-recited members, elements or method steps. The terms “comprising”, “comprises” and “comprised of” also include the term “consisting of”.

Furthermore, the terms first, second, third and the like in the description and in the claims, are used for distinguishing between similar elements and not necessarily for describing a sequential or chronological order, unless specified. It is to be understood that the terms so used are interchangeable under appropriate circumstances and that the embodiments of the invention described herein are capable of operation in other sequences than described or illustrated herein.

The term “about” as used herein when referring to a measurable value such as a parameter, an amount, a temporal duration, and the like, is meant to encompass variations of +/−10% or less, preferably +/−5% or less, more preferably +/−1% or less, and still more preferably +/−0.1% or less of and from the specified value, insofar such variations are appropriate to perform in the disclosed invention. It is to be understood that the value to which the modifier “about” refers is itself also specifically, and preferably, disclosed.

The recitation of numerical ranges by endpoints includes all numbers and fractions subsumed within the respective ranges, as well as the recited endpoints.

Unless expressly stated otherwise, each of the following terms has the indicated meaning:

“Acyl” or “carbonyl” is a radical formed by removal of the hydroxy from a carboxylic acid (i.e., R—C(═O)—). Preferred acyl groups include acetyl, formyl, and propionyl, with acetyl being most preferred.

“Alkyl” means a saturated hydrocarbon radical having 1 to 15 carbon atoms, preferably 1 to 10 carbon atoms, more preferably 1 to 5 carbon atoms, most preferably 1 to 3 carbon atoms, that may be branched or unbranched. Non-limiting examples of alkyl radicals include methyl, ethyl, n-propyl, isopropyl, n-butyl, isobutyl, sec-butyl, tert-butyl, tert-amyl, pentyl, hexyl, heptyl, octyl and the like, wherein methyl, ethyl, n-propyl, and isopropyl represent specifically preferred examples.

A “lower alkyl” is a shorter alkyl, e.g., one containing from one to about six carbon atoms. Also, as referred to herein, a “lower” alkyl, alkenyl or alkynyl moiety (e.g., “lower alkyl”) is a chain comprised of 1 to 10, preferably from 1 to 8, carbon atoms in the case of alkyl and 2 to 10, preferably 2 to 8, carbon atoms in the case of alkene and alkyne.

“Alkoxy” means an oxygen radical having a hydrocarbon chain substituent, where the hydrocarbon chain is an alkyl or alkenyl (i.e., —O-alkyl or —O-alkenyl). Examples of alkoxy radicals include methoxy, ethoxy, n-propoxy, isopropoxy, n-butoxy, isobutoxy, sec-butoxy, tert-butoxy, allyloxy and the like.

“Aryl” is an aromatic hydrocarbon ring. Aryl rings are monocyclic or fused bicyclic ring systems. Monocyclic aryl rings contain 6 carbon atoms in the ring. Monocyclic aryl rings are also referred to as phenyl rings. Bicyclic aryl rings contain from 8 to 17 carbon atoms, preferably 9 to 12 carbon atoms, in the ring. Bicyclic aryl rings include ring systems wherein one ring is aryl and the other ring is aryl, cycloalkyl, or heterocycloalkyl. Preferred bicyclic aryl rings comprise 5-, 6- or 7-membered rings fused to 5-, 6-, or 7-membered rings. Aryl rings may be unsubstituted or substituted with from 1 to 4 substituents on the ring. Aryl may be substituted with halo, cyano, nitro, hydroxy, carboxy, amino, acylamino, alkyl, heteroalkyl, haloalkyl, phenyl, aryloxy, alkoxy, heteroalkyloxy, carbamyl, haloalkyl, methylenedioxy, heteroaryloxy, or any combination thereof. Preferred aryl rings include naphthyl, tolyl, xylyl, and phenyl. The most preferred aryl ring radical is phenyl.

“Halo” or “halogen” is fluoro, chloro, bromo or iodo. Preferred halo are fluoro, chloro and bromo; more preferred typically are chloro and fluoro, especially fluoro.

The term “active ingredient” as used herein refers to one or more compounds according to the present invention or isomers, solvates, veterinary acceptable salts, metabolites or prodrugs thereof.

The term “pharmaceutically acceptable salts” or “veterinary acceptable salts” as used herein means the therapeutically active non-toxic addition salt forms which the compounds of formula are able to form and which may conveniently be obtained by treating the base form of such compounds with an appropriate base or acid. The pharmaceutically acceptable acid and base addition salts as mentioned hereinabove or hereinafter are meant to comprise the therapeutically active non-toxic acid and base addition salt forms which the compounds of Formula (I) are able to form. The pharmaceutically acceptable acid addition salts can conveniently be obtained by treating the base form with such appropriate acid. Appropriate acids comprise, for example, inorganic acids such as hydrohalic acids, e.g. hydrochloric or hydrobromic acid, sulfuric, nitric, phosphoric and the like acids; or organic acids such as, for example, acetic, propanoic, hydroxyacetic, lactic, pyruvic, oxalic (i.e. ethanedioic), malonic, succinic (i.e. butanedioic acid), maleic, fumaric, malic, tartaric, citric, methanesulfonic, ethanesulfonic, benzenesulfonic, p-toluenesulfonic, cyclamic, salicylic, p-aminosalicylic, pamoic and the like acids. Conversely said salt forms can be converted by treatment with an appropriate base into the free base form. The compounds of Formula (I) containing an acidic proton may also be converted into their non-toxic metal or amine addition salt forms by treatment with appropriate organic and inorganic bases. Appropriate base salt forms comprise, for example, the ammonium salts, the alkali and earth alkaline metal salts, e.g. the lithium, sodium, potassium, magnesium, calcium salts and the like, salts with organic bases, e.g. primary, secondary and tertiary aliphatic and aromatic amines such as methylamine, ethylamine, propylamine, isopropylamine, the four butylamine isomers, dimethylamine, diethylamine, diethanolamine, dipropylamine, diisopropylamine, di-n-butylamine, pyrrolidine, piperidine, morpholine, trimethylamine, triethylamine, tripropylamine, quinuclidine, pyridine, quinoline and isoquinoline; the benzathine, N-methyl-D-glucamine, hydrabamine salts, and salts with amino acids such as, for example, arginine, lysine and the like. Conversely the salt form can be converted by treatment with acid into the free acid form.

Moreover, salts of acids or bases which are not physiologically acceptable may also find use, for example, in the preparation or purification of a physiologically acceptable compound. All salts, whether or not derived from a physiologically acceptable acid or base, are within the scope of the present invention. The term “isomers” as used herein means all possible isomeric forms, including tautomeric forms, which the compounds of formula (I) may possess. Unless otherwise stated, the standard chemical designation refers to all possible stereochemically isomeric forms, including all diastereomers and enantiomeres (since the compounds of formula (I) may have at least one chiral center) of the basic molecular structure. More particularly, unless otherwise stated, stereogenic centers may have either the R- or S-configuration, and substituents may have either cis- or trans-configuration.

All documents cited in the present specification are hereby incorporated by reference in their entirety.

Unless otherwise defined, all terms used in disclosing the invention, including technical and scientific terms, have the meaning as commonly understood by one of ordinary skill in the art to which this invention belongs. By means of further guidance, definitions for the terms used in the description are included to better appreciate the teaching of the present invention. The terms or definitions used herein are provided solely to aid in the understanding of the invention.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

A first aspect of the invention relates to the use of derivatives of purine and pyrimidine in the treatment of feline (retro)viral diseases.

The compounds according to the present invention have been found to reduce viral load in naturally infected FIV-infected and/or FeLV-infected cats. Thus, in particular embodiments the compounds of the present invention are envisaged for use in the prevention and/or treatment of felines, more particularly cats, infected with FIV or FeLV.

Accordingly, the present invention relates to compounds according to formula (I)

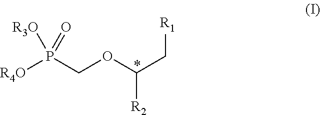

or solvates, veterinary acceptable salts, metabolites or prodrugs thereof, wherein R₁ is pyrimidine, purine, adenine, 2,6-diaminopurine, 2-aminopurine, cytosine, guanine, or an aza and or deaza analog thereof. In aza analogs, at least one C in R₁ is replaced by N; in deaza analogs, at least one N in R₁ is replaced by C. Combinations of such replacements are also included within the scope of the invention.

R₂ is hydrogen, hydroxymethyl, methyl, monohalomethyl, dihalomethyl or trihalomethyl, more preferably methyl or monohalomethyl, even more preferably methyl; and
R₃ and R₄ are hydrogen. In preferred embodiments, the abovementioned monohalomethyl, dihalomethyl and trihalomethyl are monofluoromethyl, difluoromethyl and trifluoromethyl.

In formula (I), “*” indicates a stereogenic center. Specific stereoisomers (R or S configuration) of the compounds of formula (I) refer to resolved enantiomers of the compounds for this particular stereogenic center. Accordingly the term “stereoisomerically pure” when used referring to compounds of formula (I), means that the compounds of formula (I) are stereochemically pure in the stereogenic center marked with “*”. If one or more of the groups R₁, R₂, R₃, R₄ or R₅ contains a stereogenic center, this can be of R, S or RS stereochemistry, unless stated otherwise.

In particular embodiments, the compounds of formula (I) according to the present invention are stereoisomerically pure. In more particular embodiments, the compounds of formula (I) are specific enantiomers of formula (I), which is represented as follows:

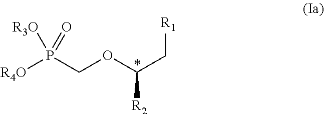

References throughout this document to the compounds of formula (I) also include a reference to the more specific enantiomers of formula (Ia).

In particular embodiments, R₁ is adenine or 2,6-diaminopurine and R₂ is methyl or monofluoromethyl. In further particular embodiments, R₂ is not methyl when R₁ is adenine.

In particular embodiments R₁ is pyrimidine, purine, 2,6-diaminopurine, 2-aminopurine, cytosine, guanine, or an aza and or deaza analog thereof.

It has moreover been found that where R₁ is 2,6-diaminopurine and R₂ is methyl in the compounds of formula (I) are particularly active against FIV and/or FeLV, more particularly the compound is more effective in reducing the viral load and more effective in the treatment of symptoms in animals infected by FIV or FeLV. Thus, in further particular embodiments, R₁ is 2,6-diaminopurine and R₂ is methyl. In this embodiment, the compound according to the present invention is 9-(2-phosphonylmethoxypropyl)-2,6-diaminopurine (PMPDAP). Specifically, in particular embodiments, the compound according to the present invention is R-PMPDAP—i.e. the enantiomer of formula (Ia)—or solvates, veterinary acceptable salts, metabolites or prodrugs thereof. In further particular embodiments, the compound according to the present invention is R-PMPDAP.

*Included within the scope of this invention are the salts of the compounds of formula (I) with one or more amino acids, especially the naturally-occurring amino acids found as protein components. The amino acid typically is one bearing a side chain with a basic or acidic group, e.g., lysine, arginine or glutamic acid, or a neutral group such as glycine, serine, threonine, alanine, isoleucine, or leucine.

Pure isomeric forms of the said compounds are defined as isomers substantially free of other enantiomeric or diastereomeric forms of the same basic molecular structure. In particular, the term “stereoisomerically pure” or “chirally pure” relates to compounds having a stereoisomeric excess of at least about 80% (i.e. at least 90% of one isomer and at most 10% of the other possible isomers), preferably at least 90%, more preferably at least 94% and most preferably at least 97%. The terms “enantiomerically pure” and “diastereomerically pure” should be understood in a similar way, having regard to the enantiomeric excess, respectively the diastereomeric excess, of the mixture in question. Consequently, if a mixture of enantiomeres is obtained during any of the following preparation methods, it can be separated by liquid chromatography using a suitable chiral stationary phase. Suitable chiral stationary phases are, for example, polysaccharides, in particular cellulose or amylose derivatives. Commercially available polysaccharide based chiral stationary phases are ChiralCel™ CA, OA, OB, OC, OD, OF, OG, OJ and OK, and Chiralpak™ AD, AS, OP(+) and OT(+). Appropriate eluents or mobile phases for use in combination with said polysaccharide chiral stationary phases are hexane and the like, modified with an alcohol such as ethanol, isopropanol and the like. The terms cis and trans are used herein in accordance with Chemical Abstracts nomenclature and refer to the position of the substituents on a ring moiety. The absolute stereochemical configuration of the compounds of formula may easily be determined by those skilled in the art while using well-known methods such as, for example, X-ray diffraction.

Those of skill in the art will also recognize that the compounds of the invention may exist in many different protonation states, depending on, among other things, the pH of their environment. While the structural formulae provided herein depict the compound in only one of several possible protonation states, it will be understood that these structures are illustrative only, and that the invention is not limited to any particular protonation state, any and all protonated forms of the compounds are intended to fall within the scope of the invention.

The compounds of the present invention may be provided as prodrugs. In particular embodiments, the prodrugs of the compounds of formula (I) are characterized by modified R₃ and/or R₄ groups. Specifically, in the prodrugs, at least one of R₃ and R₄ is CH₂C(O)N(R₅)₂, CH₂C(O)OR₅, CH₂OC(O)R₅, CH(R₅)OC(O)R₅ (R, S, or RS stereochemistry), CH₂C(R₅)₂CH₂OH, or CH₂OR₅. In particular embodiments, R₃ and R₄ are, the same or different from each other, CH₂C(O)N(R₅)₂, CH₂C(O)OR₅, CH₂OC(O)R₅, CH(R₅)OC(O)R₅ (R, S, or RS stereochemistry), CH₂C(R₅)₂CH₂OH, or CH₂OR₅; R₅ is C₁-C₂₀ alkyl, aryl or aryl-alkyl which is unsubstituted or is substituted by hydroxy, oxygen, nitrogen or halogen. In particular embodiments, the prodrugs contain identical R₃ and R₄ groups.

Upon uptake by the cells, these compounds of formula (I) can be phosphorylated such that either one of R₃ and R₄ is phosphate or diphosphate, while the other is hydrogen. Therefore, in particular embodiments, the metabolites of the compounds of formula (I) are characterized by modified R₃ or R₄ groups. Therefore, in particular embodiments, in the metabolites of the compounds of formula (I), at least one of R₃ and R₄ is phosphate or diphosphate. Preferably, in the metabolites of the compounds of formula (I), one of R₃ and R₄ is phosphate or diphosphate, whereas the other is hydrogen.

The compounds of the present invention can be prepared as known and described in the art as in EP0654037, which is incorporated by reference herein.

Most particularly, the compounds are used to reduce the viral load in felines infected with FIV or FeLV.

It is noted that infection of a feline by a virus such as FIV (acute phase as mentioned in Table 2), similar to HIV in man, is most often followed by a long asymptomatic phase, in which the felines are apparently healthy. This asymptomatic phase can persist for years and is marked by a stable viral load and absence of clinical signs. It is assumed that in this phase the viral replication is controlled by the immune system. However, due to a progressive decline in CD4⁺ T-lymphocytes, resulting in a decreased CD4/CD8 T-lymphocyte ratio, a more functional immunodeficiency may appear. This can evolve to an AIDS terminal phase with high susceptibility to secondary infections accompanied by more pronounced clinical signs such as chronic gingivostomatitis, chronic rhinitis, lymphadenopathy, glomerulonephritis, haemorrhagic enteritis, concurrent infections and weight loss with ultimately death as result.

From the literature it is known that the ability of a compound to reduce viral load in FIV-infected, but asymptomatic carriers, is not necessarily predictive of its efficacy to treat clinical symptoms. For example, Hartmann et al. showed that treatment of FIV-infected cats with 9-(2-phosphonylmethoxyethyl)adenine (PMEA) did not decrease the FIV load and still led to a 10% improvement in Karnofsky's score, whereas (S)-9-(3-fluoro-2-phosphonylmethoxypropyl)adenine (FPMPA) treatment reduced the FIV load but only led to a marginal increase (3.8%) in Karnofsky's score (Hartmann et al., J Acquir Immune Defic Syndr Hum Retrovirol 1998). Examples of clinical symptoms include but are not limited to loss of body weight, malaise, lethargy, poor coat condition, pyrexia, anemia, concurrent infections, gastroenteritis, gingivitis, neutrophenia, (recurrent) fever, leucopenia, anorexia, neoplasie, (chronic) stomatitis, (chronic) gingivostomatitis, (chronic) rhinitis, diarrhea, chronic or frequent infections of the skin, eyes, urinary tract, respiratory tract, lymphadenopathy, glomerulonephritis, haemorrhagic enteritis, diseases of the nervous system which may cause behavioral changes or seizures, abortion of litters and cancer.

The present inventors have surprisingly found that the compounds of the present invention are capable of reversing symptoms that occur in the clinical and even AIDS-terminal phase of FIV infection, during which severe immunosuppression has often extremely weakened the animal. Thus, in particular embodiments, the present invention relates to the use of the compounds of formula (I), or solvates, veterinary acceptable salts, metabolites or prodrugs thereof, for use in the treatment of FIV infections in cats with clinical symptoms. In certain embodiments, these symptoms are one or more symptoms selected from the group consisting of stomatitis, gingivitis, neurological symptoms, lethargy, weight loss and lymphadenopathy.

It has been observed that the compounds of the present invention are capable of reducing the clinical symptoms of felines infected with FIV. In particular embodiments, one or more of the clinical symptoms is reduced to at least 50% within 3 months, more particularly within 6 weeks. In certain embodiments, the Karnofsky's score modified for cats (see Example 2) increases with at least 10 units within 3 months, compared to the cat's score prior to treatment. Accordingly, a further aspect of the invention relates to the use of the compounds of the present invention in the treatment of clinical symptoms associated with FIV infections in felines. The invention thus provides methods of treating one or more clinical symptoms of FIV infection in a feline infected with FIV, which method comprises administering to said feline an effective amount of a compound as described above. In particular embodiments, the compounds of the present invention are envisaged for use in the treatment of gingivitis and/or stomatitis in a feline infected with FIV. In certain embodiments, the compounds are envisaged for increasing the Karnofsky's score modified for cats (see Example 2) with at least 10 units, preferably at least 15 units, and even more preferably at least 20 units, in a feline infected with FIV, compared to the feline's score prior to treatment.

The inventors have further developed optimal dosage regimes for the treatment of a feline infected with FIV, more particularly an FIV-infected feline with clinical symptoms, most particularly for the treatment of clinical symptoms associated with FIV. Indeed it has been found that optimal treatment of a feline infected with FIV is achieved when the compound according to the invention is administered at least once weekly, with a total dose of 10 to 175 mg/kg. Such a regimen ensures reduction of the viral load and/or reduction of clinical symptoms in a feline infected with FIV. Thus, a further aspect of the present invention provides the compounds of the present invention, for use in the treatment methods of the present invention, wherein the compound is administered at least once weekly, with a total dose of 10 to 175 mg/kg. In certain embodiments, the compound is administered via oral route. In preferred embodiments, the compound is administered via subcutaneous injections.

In a further aspect, the invention more particularly provides compounds for use in the treatment of Feline Leukemia virus (FeLV). FeLV is a gammaretrovirus within the family Retroviridae, as akin to FIV, but differing from FIV in many ways, including the pathology of the disease caused the genus which is lentivirus for FIV. Different purine and pyrimidine derivatives have been found to have a different anti-viral spectrum. The present inventors herein demonstrate that the compounds of the present invention are effective in the treatment of FeLV, both reducing the viral load and alleviating clinical symptoms.

More particularly, the present invention relates to a compound of formula (I), or solvates, veterinary acceptable salts, metabolites or prodrugs thereof for use in the prevention and treatment of felines, such as cats infected with FeLV. Most particularly, the invention provides stereoisomerically pure compounds for use in the treatment of FeLV.

More particularly, in the compound of formula (I) for use in the prevention and treatment of felines, such as cats infected with FeLV, R₁ is a pyrimidine or purine derivative, particularly pyrimidine, purine, adenine, 2,6-diaminopurine, 2-aminopurine, cytosine or guanine, and more particularly adenine, 2,6-diaminopurine or cytosine. In particular embodiments R₁ is adenine and 2,6-diaminopurine R₂ in the compound of formula (I) is hydrogen, methyl or monofluoromethyl, preferably methyl or monofluoromethyl. In particular embodiments, R₂ is methyl. In further particular embodiments, R₂ is not methyl when R₁ is adenine. R₃ and R₄ are hydrogen. In certain embodiments, the present invention relates to a stereoisomerically pure compound of the formula (I) for use in the prevention and treatment of FeLV in cats. Most particularly, the isomer of the compound of formula (I) is the specific enantiomer of formula (Ia).

In particular embodiments, the compound of formula (I) for use in the prevention and treatment of felines, such as cats infected with FeLV is R-PMPDAP, a solvate, veterinary acceptable salt, metabolite or prodrug thereof. Herein, R₁ is 2,6-diaminopurine and R₂ is methyl. Indeed it has been found that R-PMPDAP is particularly active against FeLV, more particularly the compound is more effective in reducing the viral load and more effective in the treatment of symptoms in animals infected by FeLV. Thus, in particular embodiments, the compound of formula (I) for use in the prevention and treatment of felines, such as cats infected with FeLV is R-PMPDAP. Most particularly, the invention relates to steroisochemically pure formulations of R-PMPDAP.

In further particular embodiments, the compound of formula (I) for use in the prevention and treatment of felines, such as cats infected with FeLV is (S)-9-(3-fluoro-2-phosohonomethoxypropyl)adenine (S-FPMPA), a solvate, veterinary acceptable salt, metabolite or prodrug thereof. Herein, R₁ is adenine and R₂ is monofluoromethyl. In further particular embodiments, the compound for use in the prevention and treatment of felines, such as cats infected with FeLV is S-FPMPA.

In further particular embodiments, the compound of formula (I) or (Ia) for use in the prevention and treatment of felines, such as cats infected with FeLV is 9-[2-(phosphono-methoxy)propyl]adenine (PMPA) or R-PMPA, a solvate, veterinary acceptable salt, metabolite or prodrug thereof. Herein, R₁ is adenine and R₂ is methyl. In further particular embodiments, the compound for use in the prevention and treatment of felines, such as cats infected with FeLV is PMPA or R-PMPA.

In further particular embodiments, the compound of formula (I) or (Ia) for use in the prevention and treatment of felines, such as cats infected with FeLV is 9-[2-(phosphono-methoxy)ethyl]-2,6-diaminopurine (PMEDAP) or R-PMEDAP, a solvate, veterinary acceptable salt, metabolite or prodrug thereof. Herein, R₁ is 2,6-diaminopurine and R₂ is hydrogen. In further particular embodiments, the compound for use in the prevention and treatment of felines, such as cats infected with FeLV is PMEDAP or R-PMEDAP.

In particular embodiments, the compounds are envisaged for use in the reduction of viral load in felines. In further particular embodiments, the compounds are envisaged for use in the reduction of clinical symptoms of the infection. Specifically, in particular embodiments, the compounds of the invention are envisaged for use in the treatment of clinical signs selected from the group consisting of poor appetite & or weight loss, fever, apathy, enlarged lymph nodes, pale mucous membranes, gastrointestinal disorders, lymphosarcoma, secondary infections due to the weakened immune system, difficulty breathing, general inflammation of the oral cavity, lymphadenopathy, diarrhea, tumors and gingivitis/stomatitis in a feline infected with FeLV. In further particular embodiments, the compounds of the invention are envisaged for use in the treatment of gingivitis and/or stomatitis in a feline infected with FeLV. In certain embodiments, the compounds are envisaged for increasing the Karnofsky's score modified for cats (see Example 2) with at least 10 units, preferably at least 15 units, and even more preferably at least 20 units, in a feline infected with FeLV, compared to the feline's score prior to treatment.

The inventors have further developed optimal dosage regimes for the treatment of a feline infected with FeLV. Indeed it has been found that optimal treatment of a feline infected with FeLV is achieved when the compound according to the invention is administered at least once weekly, with a total dose of 10 to 175 mg/kg. Such a regimen ensures reduction of the viral load and/or reduction of clinical symptoms in a feline infected with FeLV. Thus, a further aspect of the present invention provides the compounds of the present invention, for use in the treatment methods of the present invention, wherein the compound is administered at least once weekly, with a total dose of 10 to 175 mg/kg. In certain embodiments, the compound is administered via oral route. In preferred embodiments, the compound is administered via subcutaneous injections.

In view of the efficacy of the compounds of the present invention against both FIV and FeLV infections in felines, a further aspect of the invention relates to the use of these compounds in the treatment of a feline co-infected with FIV and FeLV.

Thus, in particular embodiments, the present invention relates to a compound of formula (I), or solvates, veterinary acceptable salts, metabolites or prodrugs thereof, for use in the treatment of cats co-infected with FeLV and with FIV, wherein R₁ is a pyrimidine or purine derivative, and R₂ in the compound of formula (I) is hydrogen, methyl or monofluoromethyl, and R₃ and R₄ are hydrogen,

In particular embodiments, R₁ is selected from pyrimidine, purine, adenine, 2,6-diaminopurine, 2-aminopurine, cytosine or guanine. In more particular embodiments, R₁ is selected from adenine and 2,6-diaminopurine;
In particular embodiments, R₂ is selected from methyl or monofluoromethyl. In more particular embodiments R₂ is methyl. In further particular embodiments, R₂ is not methyl when R₁ is adenine.

In certain embodiments, the compound of formula (I) for use in the treatment of cats co-infected with FeLV and FIV is stereoisomerically pure. In further particular embodiments, the invention provides stereoisomerically pure isomers of the compounds of the present invention, according to formula (Ia).

It has been found that, where R₁ is 2,6-diaminopurine and R₂ is methyl, the compounds according to the present invention are particularly effective in the treatment of a feline, more particularly a cat co-infected with FIV and FeLV. Thus, in particular embodiments, the compound of formula (I) for use in the treatment of felines, such as cats co-infected with FIV and FeLV is R-PMPDAP, a solvate, veterinary acceptable salt, metabolite or prodrug thereof. In particular embodiments, the compound of formula (I) for use in the treatment of felines, such as cats co-infected with FIV and FeLV is R-PMPDAP.

In particular embodiments, the compound of formula (I) for use in the treatment of felines, such as cats co-infected with FIV and FeLV is (S)-9-(3-fluoro-2-phosohonomethoxypropyl)adenine (S-FPMPA), a solvate, veterinary acceptable salt, metabolite or prodrug thereof. Herein, R₁ is adenine and R₂ is monofluoromethyl. In further particular embodiments, the compound for use in the treatment of felines, such as cats co-infected with FIV and FeLV is S-FPMPA.

In particular embodiments it is envisaged that the compounds of the present invention are used to reduce the viral load of FIV and FeLV in a feline with or without clinical symptoms of one or both of these diseases. In particular embodiments, the compounds are envisaged for use in the treatment of one or more of the clinical symptoms associated with these diseases mentioned above.

More particularly, the present invention provides compounds according to the present invention for use in the treatment of one or more symptoms selected from the group consisting of poor appetite, loss of body weight, neutrophenia, fever, leucopenia, anorexia, neoplasie, malaise, apathy, poor coat condition, pyrexia, anemia, concurrent infections, gastroenteritis, gingivitis, stomatitis, gingivostomatitis, rhinitis, diarrhea, chronic or frequent infections of the skin, eyes, urinary tract, respiratory tract, lymphosarcoma, difficult breathing, general inflammation of the oral cavity, diarrhea, lymphadenopathy, pale mucous membranes, gastrointestinal disorders, glomerulonephritis, haemorrhagic enteritis, diseases of the nervous system which may cause behavioral changes or seizures, abortion of litters, tumours and cancer, in felines infected with FIV and FeLV. In certain embodiments, the compounds are envisaged for increasing the Karnofsky's score modified for cats (see Example 2) with at least 10 units, preferably at least 15 units, and even more preferably at least 20 units, in a feline infected with FIV and FeLV, compared to the feline's score prior to treatment.

In certain embodiments, the present invention relates to a stereoisomerically pure compound of the formula (I) for use in the prevention and treatment of FeLV and FIV in cats.

The inventors have further developed optimal dosage regimes for the treatment of a feline co-infected with FIV and FeLV. Indeed it has been found that optimal treatment of a feline co-infected with FIV and FeLV is achieved when the compound according to the invention is administered at least once weekly, with a total dose of 10 to 175 mg/kg. Such a regimen ensures reduction of the viral load and/or reduction of clinical symptoms in a feline co-infected with FIV and FeLV. Thus, a further aspect of the present invention provides the compounds of the present invention, for use in the treatment methods of the present invention, wherein the compound is administered at least once weekly, with a total dose of 10 to 175 mg/kg. In certain embodiments, the compound is administered via oral route. In preferred embodiments, the compound is administered via subcutaneous injections.

The present invention further provides formulations of the compounds of the present invention, which are particularly suited for the therapeutic use envisaged. The compounds of the invention may be formulated with conventional carriers and excipients, which will be selected in accordance with ordinary practice. Tablets will contain excipients, glidants, fillers, binders and the like. Aqueous formulations are prepared in sterile form, and when intended for delivery by other than oral administration generally will be isotonic. Formulations optionally contain excipients such as those set forth in the “Handbook of Pharmaceutical Excipients” (1986) and include sodium hydroxide, ascorbic acid and other antioxidants, chelating agents such as EDTA, carbohydrates such as dextrin, hydroxyalkylcellulose, hydroxyalkylmethylcellulose, stearic acid and the like.

Subsequently, the term “pharmaceutically acceptable carrier” or “veterinary acceptable carrier” as used herein means any material or substance with which the active ingredient is formulated in order to facilitate its application or dissemination to the locus to be treated, for instance by dissolving, dispersing or diffusing the said composition, and/or to facilitate its storage, transport or handling without impairing its effectiveness. The pharmaceutically acceptable carrier or veterinary acceptable carrier may be a solid or a liquid or a gas which has been compressed to form a liquid, i.e. the compositions of this invention can suitably be used as concentrates, emulsions, solutions, granulates, dusts, sprays, aerosols, suspensions, ointments, creams, tablets, pellets or powders.

Suitable pharmaceutical carriers for use in the said pharmaceutical compositions and their formulation are well known to those skilled in the art, and there is no particular restriction to their selection within the present invention. They may also include additives such as wetting agents, dispersing agents, stickers, adhesives, emulsifying agents, solvents, coatings, antibacterial and antifungal agents (for example phenol, sorbic acid, chlorobutanol, benzyl alcohol), isotonic agents (such as sugars or sodium chloride) and the like, provided the same are consistent with pharmaceutical practice, i.e. carriers and additives which do not create permanent damage to mammals. The pharmaceutical compositions of the present invention may be prepared in any known manner, for instance by homogeneously mixing, coating and/or grinding the active ingredients, in a one-step or multi-steps procedure, with the selected carrier material and, where appropriate, the other additives such as surface-active agents may also be prepared by micronisation, for instance in view to obtain them in the form of microspheres usually having a diameter of about 1 to 10 μm, namely for the manufacture of microcapsules for controlled or sustained release of the active ingredients.

Suitable surface-active agents, also known as emulgent or emulsifier, to be used in the pharmaceutical compositions of the present invention are non-ionic, cationic and/or anionic materials having good emulsifying, dispersing and/or wetting properties. Suitable anionic surfactants include both water-soluble soaps and water-soluble synthetic surface-active agents. Suitable soaps are alkaline or alkaline-earth metal salts, unsubstituted or substituted ammonium salts of higher fatty acids (C₁₀-C₂₂), e.g. the sodium or potassium salts of oleic or stearic acid, or of natural fatty acid mixtures obtainable form coconut oil or tallow oil. Synthetic surfactants include sodium or calcium salts of polyacrylic acids; fatty sulphonates and sulphates; sulphonated benzimidazole derivatives and alkylarylsulphonates. Fatty sulphonates or sulphates are usually in the form of alkaline or alkaline-earth metal salts, unsubstituted ammonium salts or ammonium salts substituted with an alkyl or acyl radical having from 8 to 22 carbon atoms, e.g. the sodium or calcium salt of lignosulphonic acid or dodecylsulphonic acid or a mixture of fatty alcohol sulphates obtained from natural fatty acids, alkaline or alkaline-earth metal salts of sulphuric or sulphonic acid esters (such as sodium lauryl sulphate) and sulphonic acids of fatty alcohol/ethylene oxide adducts. Suitable sulphonated benzimidazole derivatives preferably contain 8 to 22 carbon atoms. Examples of alkylarylsulphonates are the sodium, calcium or alcanolamine salts of dodecylbenzene sulphonic acid or dibutyl-naphtalenesulphonic acid or a naphtalene-sulphonic acid/formaldehyde condensation product. Also suitable are the corresponding phosphates, e.g. salts of phosphoric acid ester and an adduct of p-nonylphenol with ethylene and/or propylene oxide, or phospholipids. Suitable phospholipids for this purpose are the natural (originating from animal or plant cells) or synthetic phospholipids of the cephalin or lecithin type such as e.g. phosphatidylethanolamine, phosphatidylserine, phosphatidylglycerine, lysolecithin, cardiolipin, dioctanylphosphatidyl-choline, dipalmitoylphoshatidyl-choline and their mixtures.

Suitable non-ionic surfactants include polyethoxylated and polypropoxylated derivatives of alkylphenols, fatty alcohols, fatty acids, aliphatic amines or amides containing at least 12 carbon atoms in the molecule, alkylarenesulphonates and dialkylsulphosuccinates, such as polyglycol ether derivatives of aliphatic and cycloaliphatic alcohols, saturated and unsaturated fatty acids and alkylphenols, said derivatives preferably containing 3 to 10 glycol ether groups and 8 to 20 carbon atoms in the (aliphatic) hydrocarbon moiety and 6 to 18 carbon atoms in the alkyl moiety of the alkylphenol. Further suitable non-ionic surfactants are water-soluble adducts of polyethylene oxide with poylypropylene glycol, ethylenediaminopolypropylene glycol containing 1 to 10 carbon atoms in the alkyl chain, which adducts contain 20 to 250 ethyleneglycol ether groups and/or 10 to 100 propyleneglycol ether groups. Such compounds usually contain from 1 to 5 ethyleneglycol units per propyleneglycol unit. Representative examples of non-ionic surfactants are nonylphenol-polyethoxyethanol, castor oil polyglycolic ethers, polypropylene/polyethylene oxide adducts, tributylphenoxypolyethoxyethanol, polyethyleneglycol and octylphenoxypolyethoxyethanol. Fatty acid esters of polyethylene sorbitan (such as polyoxyethylene sorbitan trioleate), glycerol, sorbitan, sucrose and pentaerythritol are also suitable non-ionic surfactants.

Suitable cationic surfactants include quaternary ammonium salts, particularly halides, having 4 hydrocarbon radicals optionally substituted with halo, phenyl, substituted phenyl or hydroxy; for instance quaternary ammonium salts containing as N-substituent at least one C₈-C₂₂ alkyl radical (e.g. cetyl, lauryl, palmityl, myristyl, oleyl and the like) and, as further substituents, unsubstituted or halogenated lower alkyl, benzyl and/or hydroxy-lower alkyl radicals.

A more detailed description of surface-active agents suitable for this purpose may be found for instance in “McCutcheon's Detergents and Emulsifiers Annual” (MC Publishing Crop., Ridgewood, N.J., 1981), “Tensid-Taschenbuch’, 2 d ed. (Hanser Verlag, Vienna, 1981) and “Encyclopaedia of Surfactants, (Chemical Publishing Co., New York, 1981).

While it is possible for the active ingredients to be administered alone it is preferable to present them as pharmaceutical formulations. The formulations for veterinary use of the present invention comprise at least one active ingredient, as above described, together with one or more veterinary acceptable carriers therefore and optionally other therapeutic ingredients. The carrier(s) optimally are “acceptable” in the sense of being compatible with the other ingredients of the formulation and not deleterious to the recipient thereof. The formulations include those suitable for oral or parenteral (including subcutaneous, intraperitoneal, intramuscular, intravenous, intradermal, intrathecal and epidural) administration. The formulations may conveniently be presented in unit dosage form and may be prepared by any of the methods well known in the art of pharmacy. In particular embodiments, as indicated above, the compounds of the present invention are provided as oral or injectable formulations.

Such methods include the step of bringing into association the active ingredient with the carrier which constitutes one or more accessory ingredients. In general the formulations are prepared by uniformly and intimately bringing into association the active ingredient with liquid carriers or finely divided solid carriers or both, and then, if necessary, shaping the product.

Formulations of the present invention suitable for oral administration may be presented as discrete units such as capsules, cachets, enteric capsules or tablets each containing a predetermined amount of the active ingredient; as a powder or granules; as solution or a suspension in an aqueous liquid or a non-aqueous liquid; or as an oil-in-water liquid emulsion or a water-in-oil liquid emulsion. The active ingredient may also be presented as a bolus, electuary or paste.

A tablet may be made by compression or molding, optionally with one or more accessory ingredients. Compressed tablets may be prepared by compressing in a suitable machine the active ingredient in a free-flowing form such as a powder or granules, optionally mixed with a binder, lubricant, inert diluent, preservative, surface active or dispersing agent. Molded tablets may be made by molding in a suitable machine a mixture of the powdered compound moistened with an inert liquid diluent. The tablets may optionally be coated or scored and may be formulated so as to provide slow or controlled release of the active ingredient therein.

The formulations are optionally applied as a topical ointment or cream containing the active ingredient(s) in an amount of, for example, 0.075 to 20% w/w (including active ingredient(s) in a range between 0.1% and 20% in increments of 0.1% w/w such as 0.6% w/w, 0.7% w/w, etc), preferably 0.2 to 15% w/w and most preferably 0.5 to 10% w/w. When formulated in an ointment, the active ingredients may be employed with either a paraffinic or a water-miscible ointment base. Alternatively, the active ingredients may be formulated in a cream with an oil-in-water cream base. If desired, the aqueous phase of the cream base may include, for example, at least 30% w/w of a polyhydric alcohol, i.e. an alcohol having two or more hydroxyl groups such as propylene glycol, butane 1,3-diol, mannitol, sorbitol, glycerol and polyethylene glycol (including PEG400) and mixtures thereof. The topical formulations may desirably include a compound which enhances absorption or penetration of the active ingredient through the skin or other affected areas. Examples of such dermal penetration enhancers include dimethylsulfoxide and related analogs.

The oily phase of the emulsions of this invention may be constituted from known ingredients in a known manner. While the phase may comprise merely an emulsifier (otherwise known as an emulgent), it desirably comprises a mixture of at least one emulsifier with a fat or an oil or with both a fat and an oil. Optionally, a hydrophilic emulsifier is included together with a lipophilic emulsifier which acts as a stabilizer. It is also preferred to include both an oil and a fat. Together, the emulsifier(s) with or without stabilizer(s) make up the so-called emulsifying wax, and the wax together with the oil and fat make up the so-called emulsifying ointment base which forms the oily dispersed phase of the cream formulations.

The choice of suitable oils or fats for the formulation is based on achieving the desired cosmetic properties, since the solubility of the active compound in most oils likely to be used in pharmaceutical emulsion formulations is very low. Thus the cream should optionally be a non-greasy, non-staining and washable product with suitable consistency to avoid leakage from tubes or other containers. Straight or branched chain, mono- or dibasic alkyl esters such as di-isoadipate, isocetyl stearate, propylene glycol diester of coconut fatty acids, isopropyl myristate, decyl oleate, isopropyl palmitate, butyl stearate, 2-ethylhexyl palmitate or a blend of branched chain esters known as Crodamol CAP may be used, the last three being preferred esters. These may be used alone or in combination depending on the properties required. Alternatively, high melting point lipids such as white soft paraffin and/or liquid paraffin or other mineral oils can be used.

Preferred unit dosage formulations are those containing an effective dose, as hereinabove recited, or an appropriate fraction thereof, of an active ingredient. It should be understood that in addition to the ingredients particularly mentioned above the formulations of this invention may include other agents conventional in the veterinary art having regard to the type of formulation in question, for example those suitable for oral administration may include flavoring agents.

Compounds of the invention can provided as controlled release pharmaceutical formulations containing as active ingredient one or more compounds of the invention (“controlled release formulations”) in which the release of the active ingredient can be controlled and regulated to allow less frequency dosing or to improve the pharmacokinetic or toxicity profile of a given invention compound. Controlled release formulations adapted for oral administration in which discrete units comprising one or more compounds of the invention can be prepared according to conventional methods. Additional ingredients may be included in order to control the duration of action of the active ingredient in the composition. Control release compositions may thus be achieved by selecting appropriate polymer carriers such as for example polyesters, polyamino acids, polyvinyl pyrrolidone, ethylene-vinyl acetate copolymers, methylcellulose, carboxymethylcellulose, protamine sulfate and the like. The rate of drug release and duration of action may also be controlled by incorporating the active ingredient into particles, e.g. microcapsules, of a polymeric substance such as hydrogels, polylactic acid, hydroxymethylcellulose, polymethyl methacrylate and the other above-described polymers. Such methods include colloid drug delivery systems like liposomes, microspheres, microemulsions, nanoparticles, nanocapsules and so on. Depending on the route of administration, the veterinary composition may require protective coatings. Pharmaceutical forms suitable for injectable use include sterile aqueous solutions or dispersions and sterile powders for the extemporaneous preparation thereof. Typical carriers for this purpose therefore include biocompatible aqueous buffers, ethanol, glycerol, propylene glycol, polyethylene glycol and the like and mixtures thereof.

In view of the fact that, when several active ingredients are used in combination, they do not necessarily bring out their joint therapeutic effect directly at the same time in the cat to be treated, the corresponding composition may also be in the form of a medical kit or package containing the two ingredients in separate but adjacent repositories or compartments. In the latter context, each active ingredient may therefore be formulated in a way suitable for an administration route different from that of the other ingredient, e.g. one of them may be in the form of an oral or parenteral formulation whereas the other is in the form of an ampoule for intravenous injection.

A particular embodiment of this invention relates to various precursor or “prodrug” forms of the compounds of the present invention. It may be desirable to formulate the compounds of the present invention in the form of a chemical species which itself is not significantly biologically-active, but which when delivered to the cat will undergo a chemical reaction catalyzed by the normal function of the body of the cat, inter alia, enzymes present in the stomach or in blood serum, said chemical reaction having the effect of releasing a compound as defined herein. The term “prodrug” thus relates to these species which are converted in vivo into the active pharmaceutical ingredient.

The prodrugs of the present invention can have any form suitable to the formulator, for example, esters, more specifically alkylesters, are non-limiting common prodrug forms. In the present case, however, the prodrug may necessarily exist in a form wherein a covalent bond is cleaved by the action of an enzyme present at the target locus. For example, a C—C covalent bond may be selectively cleaved by one or more enzymes at said target locus and, therefore, a prodrug in a form other than an easily hydrolysable precursor, inter alia an ester, an amide, and the like, may be used. The counterpart of the active pharmaceutical ingredient in the prodrug can have different structures such as an amino acid or peptide structure, alkyl chains, sugar moieties and others as known in the art.

For the purposes of the present invention the term “therapeutically suitable prodrug” is defined herein as “a compound modified in such a way as to be transformed in vivo to the therapeutically active form, whether by way of a single or by multiple biological transformations, when in contact with the tissues of the cat to which the prodrug has been administered, and without undue toxicity, irritation, or allergic response, and achieving the intended therapeutic outcome”.

FIV and FeLV inhibitory activity can be readily detected using the assays described herein, as well as assays generally known to those of ordinary skill in the art. In general, cat cells are infected with FIV and/or FeLV and are incubated with or without compounds to be tested. A more detailed description is provided in the examples.

### EXAMPLES

The following examples are provided for the purpose of illustrating the present invention and by no means are meant and in no way should be interpreted to limit the scope of the present invention.

### Example 1

### Inhibition of Feline Leukemia Virus Replication by R-PMPDAP in Cell Culture

### Materials and Methods

The compounds were dissolved in a 0.05 N sodium hydroxide solution at a concentration of 10 mg/ml. Crandell Reese Feline kidney (CrFK) cells were grown in Dulbecco minimum essential medium (DMEM, Life Technologies) containing 1% sodium bicarbonate (Life Technologies) and 5% fetal calf serum (FCS, Biochrom). In a 96-well plate 5000 CrFK cells were seeded and incubated for 24 h at 37° C. in a humid atmosphere containing 5% CO2. Subsequently cells were washed with 100 μl phosphate buffered saline (PBS) containing 50 μg/ml DEAE-dextran and inoculated with 100 CCID₅₀ FeLV in presence of increasing doses of the compounds (0.4; 2; 10 and 50 μg/ml). After 2 h of incubation allowing the virus to enter the cells, the supernatant was removed and the cells were washed with PBS. DMEM including 5% FCS and containing increasing doses of the compounds were added to the infected cells. Infected cells without compounds were included as positive controls (virus control) and uninfected cells were included as negative controls (cell control). The cells were incubated for six days when viral supernatant was collected and analyzed by enzyme-linked immunosorbent assay (ELISA) for FeLV p27 antigen production and real time RT-qPCR for FeLV RNA production. For p27 detection, 50 μl supernatant was incubated for 10 min in 1% TritonX100 and applied on pre-coated ELISA plates following the instructions of the supplier (European Veterinary Laboratory). For FeLV RNA detection, 140 μl of the supernatant was extracted using the QIAamp viral RNA kit (Qiagen). The extracted RNA was converted to cDNA by means of the Taqman Reverse Transcription Reagents kit using random hexamers and the suppliers protocol (Applied Biosystems). Real time PCR was performed using the TaqMan Fast Universal PCR Mastermix (Applied Biosystems) and the standard Fast cycling protocol using the StepOne cycler (Applied Biosystems). In the PCR mixture an optimized 300 nM of each forward and reverse primers was used and 100 nM FAM-BHQ1 labeled probe as published by Cattori and Hofmann-Lehmann (2008). EC₅₀-values were determined as the concentration of compound that inhibited 50% of the viral RNA or p27 production as compared with virus controls.

### Results

The concentration that effectively inhibits 50% percent (EC₅₀) of the FeLV replication as measured by p27 ELISA and quantitative RT-PCR (RT-qPCR) is given in the Table 3. The values given in Table 3 represent mean values (±standard deviation) of three independent assays.

TABLE 3
EC₅₀ values of FeLV replication as measured
by ELISA and quantitative RT-PCR.

| Technique | EC₅₀ R-PMPDAP (μg/ml) |
|---|---|
| p27 ELISA | 0.030 ± 0.006 |
| RT-qPCR | 0.039 ± 0.024 |

### Example 2

### R-PMPDAP Treatment of Clinically Ill Cats Naturally Infected with FIV

### Materials and Methods

The compounds were dissolved to a concentration ranging between 50 and 250 mg/mL in an appropriate aqueous buffered sodium hydroxide solution close to neutral pH conditions (pH between 6 and 9).

The formulated compounds were administered via the subcutaneous route at least once weekly at total dose rates ranging between 10 and 175 mg/kg per week. Treatment duration was between 1 week and 3 months. The treated cats were clinically ill cats naturally infected with FIV, and were exhibiting various symptoms.

### Results

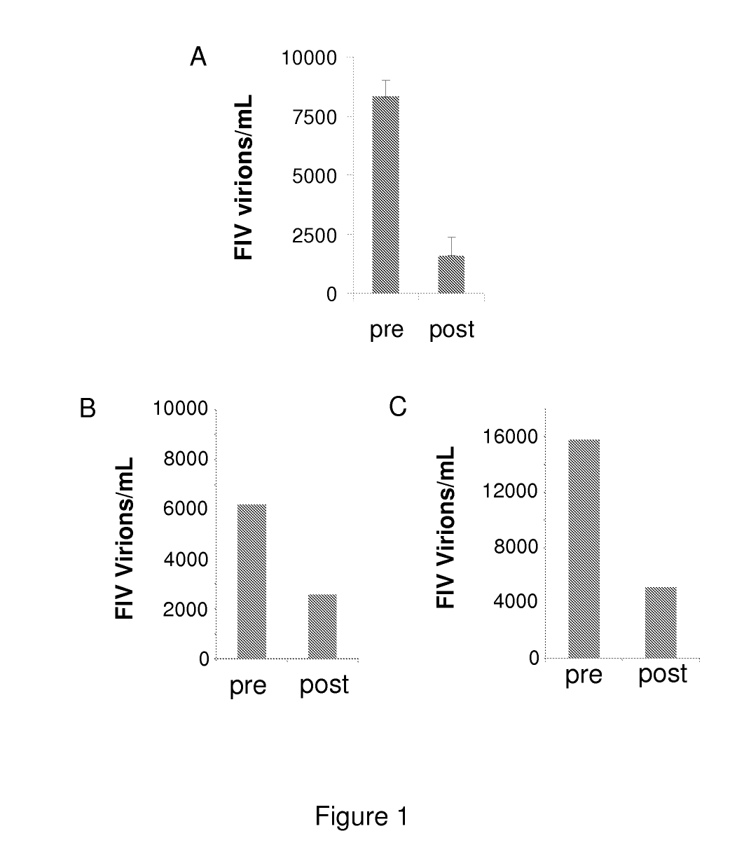

The results of the treatment of cats with specific symptoms are discussed below.
Cats with oral signs.
Oral signs can present themselves as, but are not limited to, stomatitis, gingivitis, faucitis, glossitis, periodontitis, gingivostomatitis, ulcerations of the tonsils and tongue, salivation etc. Example of the efficacy of the compounds for the treatment of stomatitis and gingivitis are given below.
   Cat with severe stomatitis.
   The FIV-positive cat had a severe case of caudal stomatitis as well as buccostomatitis. Upon treatment, the stomatitis decreased significantly (swelling and redness disappeared). No other treatment was given concomitantly.
   Cat with severe gingivitis
   The FIV-positive cat had a severe case of gingivitis with spontaneous bleeding. Upon treatment, the gingivitis decreased significantly. Spontaneous bleeding was no longer observed and the bloody red inflammation diminished to a slightly pinkish observation. No other treatment was given concomitantly.
Cats with high viral load
FIV, as a retrovirus, reverse transcribes its viral RNA genome into proviral DNA which is subsequently inserted into the genome of its host. Viral RNA (viral load) detection in plasma indicates that active FIV replication is ongoing and is thus a measure of the viral pressure. Reduction of viral load is important in controlling FIV infection in the cat. The formulated compounds significantly reduce the viral load (expressed as FIV virions per mL plasma) in FIV-positive cats. The graphs in FIGS. 1A, B and C represent the viral load pre and post treatment with the compounds in three different cats. No other treatment was given concomitantly.
Lethargic and emaciated cat, with severe weight loss
The FIV-positive cat was presented to the veterinarian with the following clinical signs: lethargy, emaciation, difficulty to walk, unable to jump up/off a chair, no desire to go outdoors, prolonged sleeping patterns. Prognosis was to euthanize the cat.
Treatment with the compounds was initiated and within a matter of weeks, the cat returned to normal, gained weight (0.6 kg), walked and played around, stayed outdoors for several consecutive days. The cat's general condition returned to normal. No other treatment was given concomitantly.
Cat with lymphadenopathy (swollen/enlarged lymph nodes)
A male FIV-positive cat with swollen Lnn. poplitei (score 4; severity is scored on a scale from 0 to 10 with 0 representing a normal clinical picture and 10 being the most severe manifestation) was treated with the compounds. Within two weeks the swelling went down to a score of 2. At the end of the 6-week treatment period with the compounds a score of 1 was noted; 0 representing a normal clinical picture. The same was noted for a female FIV-positive cat. Before treatment the Lnn. poplitei were swollen (score 2). Two weeks into treatment the lymphnodes returned to normal (score 0) which was maintained throughout the 6-week treatment period with the compounds.
Similar observations were made for two FIV-positive cats. When treatment was initiated the Lnn. mandibulares were swollen (score 2 and 3, respectively). The returned to normal (score 0) by the end of the 6-week treatment with the compounds.
Cat with inflammation of the eye
A female FIV-positive cat suffered from chronic inflammation of the eye before treatment with the compounds was initiated despite concurrent antibacterial treatment. Following treatment, the eye was on its way to full recovery.
Cat with gastrointestinal tract signs
A male FIV-positive cat with chronic daily diarrhea was treated with the compounds. The feces returned to normal within two weeks.
Cat with neurological symptoms—central nervous system (CNS) involvement
A male FIV-positive cat suffering from acute paresis of the left front and hind legs was treated with the formulated compounds starting one day following the presentation of the neurological symptoms (CNS involvement and peripheral neuropathy suspected). No other treatment was given concomitantly. One week following treatment the cat was able to sit up straight and eat on its own. Treatment was continued for another four weeks after which the cat was able to walk, climb up and down stairs, and eat on its own. A full recovery was observed shortly thereafter.
Cats with low Karnofsky's score
The Karnofsky's score modified for cats (Hartmann and Kuffer, Eur J Med Res 1998) is an objective measure (on a scale of 0 to 100%) for the quality of life and well-being of the cat. A score of 0% represents death, whereas 100% indicates that the cat is able to carry out normal activities, presents a normal behavior, and has no complaints and no evidence of clinical signs. The Karnofsky's score has proven its validity in cats to assess and compare the efficacy of antiviral compounds (Hartmann et al., J Acquir Immune Defic Syndr Hum Retrovirol 1998). Table 4 summarizes the Karnofsky's score of two FIV-positive cats before, during and post treatment with the compounds. No other treatment was given concomitantly. A significant increase in the cats' quality of life and well-being was noted in both cases following compound treatment.

TABLE 4
Karnofsky's score of FIV-positive cats before,
during and post treatment with the compounds

| | | | | 1 month post |
|---|---|---|---|---|
| | Before | During | End of | cessation of |
| Cat | treatment | treatment | treatment | treatment |
| A | 50% | 70% | 90% | 90% |
| B | 30.5% | 50% | 50% | 35% |

### Example 3

### R-PMPDAP Treatment of Cats Naturally Infected with FeLV

### Materials and Methods

The compounds were dissolved in an appropriate aqueous buffered sodium hydroxide solution at concentration ranging between 50 and 250 mg/ml and close to neutral pH conditions (pH between 6 and 9). The formulated compounds were administered via the subcutaneous route at least once weekly at total dose rates ranging between 10 and 175 mg/kg per week. Treatment duration was between 1 week and 3 months.

### Results

Cat with high viral load (viremic cat)
A female FeLV-positive cat in which the FeLV viral load was quantified using RT-qPCR (Cattori and Hofmann-Lehmann, 2008) was treated with the compounds. The viral load decreased significantly from 15500 to 3200 FeLV virions per mL plasma.
Cat with clinical symptoms
A male FeLV-positive cat with FeLV associated clinical signs such as oral inflammation, lymphadenopthy, diarrhea etc leading to a low Karnofsky's score of 58.5% was treated with the compounds. Following treatment the clinical signs ameliorated. Consequently, the Karnofsky's score increased to 80% at the end of the 3-week treatment period.

### Example 4

### Inhibition of Replication of Both Feline Leukemia Virus and Feline Immunodeficiency Virus by R-PMPDAP in Co-Infected Cell Cultures

### Materials and Methods

The compounds were dissolved in a 0.05 N sodium hydroxide solution at a concentration of 10 mg/ml. Reference compounds PMEDAP and PMEA were dissolved in a sodium bicarbonate buffer at a concentration of 10 mg/ml.

Crandell Reese Feline kidney (CrFK) cells were grown in Dulbecco minimum essential medium (DMEM, Life Technologies) containing 1% sodium bicarbonate (Life Technologies) and 5% fetal calf serum (FCS, Biochrom). In a 96-well plate 5000 CrFK cells were seeded and incubated for 24 h at 37° C. in a humid atmosphere containing 5% CO2. Subsequently cells were washed with 100 μl phosphate buffered saline (PBS) containing 50 μg/ml DEAE-dextran and co-infected with 100 CCID₅₀ FeLV and 100 CCID₅₀ FIV-Ut113 in presence of increasing doses of the compounds (0.4; 2; 10 and 50 μg/ml). After 2 h of incubation allowing the virus to enter the cells, the supernatant was removed and the cells were washed with PBS. DMEM including 5% FCS and containing increasing doses of the compounds were added to the infected cells. Infected cells without compounds were included as positive controls (virus control) and uninfected cells were included as negative controls (cell control). The cells were incubated for six days when viral supernatant was collected and analyzed by ELISA for FeLV p27 and FIV p24 antigen production and real time RT-qPCR for FeLV and FIV RNA production. For p27 detection, 50 μl supernatant was incubated for 10 min in 1% TritonX100 and applied on pre-coated ELISA plates following the instructions of the supplier (European Veterinary Laboratory). For FIV p24 ELISA 100 μl supernatant was incubated for 10 min in 1% TritonX100 and applied on a maxisorp plate (Nunc) that was pre-coated with monoclonal anti-p24 antibody 11C7C7C1 and blocked with 5% FCS in PBS. Subsequently the amount of FIV p24 was detected by a monoclonal biotinylated antibody 5E6D11 followed by a colorimetric reaction which is based on extravidin peroxidase (Sigma) and OPD substrate (Sigma).

### Results

The concentration that effectively inhibits 50% percent (EC₅₀) of the FeLV and FIV replication as measured by ELISA and quantitative RT-PCR is given in the Table below.

| EC₅₀ (μg/ml)* | R-PMPDAP |
|---|---|
| FIV ELISA (p24) | 0.332 ± 0.035 |
| FIV RT-qPCR | 0.258 ± 0.024 |
| FeLV ELISA (p27) | 0.062 ± 0.010 |
| FeLV RT-qPCR | 0.095 ± 0.050* |

*values represent mean values (±standard deviation) of three independent assays

### Example 5

### R-PMPDAP Treatment of Cats Naturally Co-Infected with FIV and FeLV

### Materials and Methods

The compounds were dissolved in an appropriate aqueous buffered sodium hydroxide solution (at concentration ranging between 50 and 250 mg/ml and close to neutral pH conditions (pH between 6 and 9). The formulated compounds were administered via the subcutaneous route at least once weekly at total dose rates ranging between 10 and 175 mg/kg per week. Treatment duration was between 1 week and 3 months.

### Results

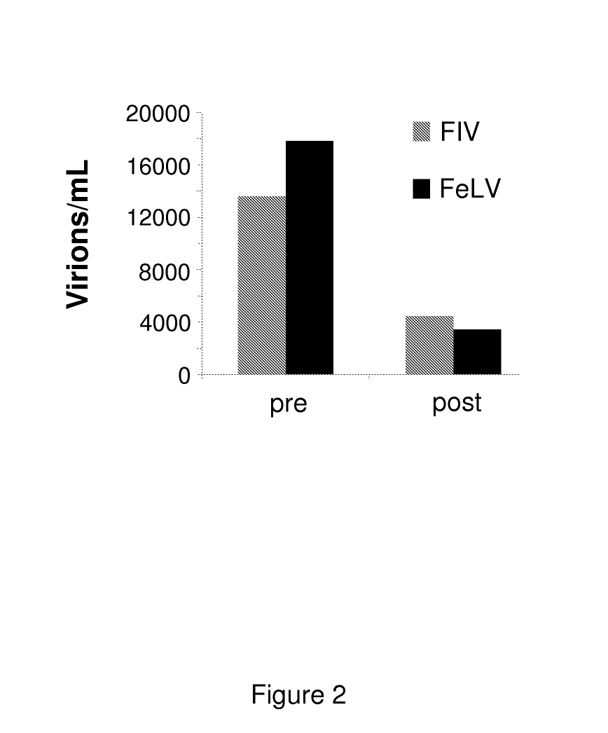

FIV and FeLV, as retroviruses, reverse transcribe their viral RNA genome into proviral DNA which is subsequently inserted into the genome of its host. Viral RNA (viral load) detection in plasma indicates that active FIV/FeLV replication is ongoing and is thus a measure of the viral pressure (and viraemia). Reduction of viral load is important in controlling FIV/FeLV infection in the cat. The formulated compounds significantly reduce the viral load (expressed as FIV/FeLV virions per mL plasma) in FIV/FeLV-positive cats. The graph in FIG. 2 represents the viral load pre and post treatment with the compounds in a cat co-infected with FIV and FeLV. No other treatment was given concomitantly.

### REFERENCES CITED

Bendinelli M, Pistello M, Lombardi S, Poli A, Garzelli C, Matteucci D, Ceccherini-Nelli L, Malvaldi G and Tozzini F (1995) Feline immunodeficiency virus: an interesting model for AIDS studies and an important cat pathogen. Clin Microbiol Rev 8(1):87-112.
Cattori V, Hofmann-Lehmann R (2008) Absolute quantitation of feline leukemia virus proviral DNA and viral RNA loads by TaqMan real-time PCR and RT-PCR. Meth Mol Biol 429:73-87.
Courchamp F (1996) Epidemiological study of Feline Immunodeficiency Virus in domestic cat populations (Felis catus), PhD Thesis University Claude Bernard—Lyon I.
de Mari K, Maynard L, Sanquer A, Lebreux B, Eun H (2004) Therapeutic Effects of Recombinant Feline Interferon-co on Feline Leukemia Virus (FeLV)-Infected and FeLV/Feline Immunodeficiency Virus (FIV)-Coinfected Symptomatic Cats. J Vet Int Med 18(4) 477-482.
Hartmann K (1998) Feline immunodeficiency virus infection: an overview. Vet J 155(2):123-137.
Hartmann K, Kuffer M. (1998) Karnofsky's score modified for cats. Eur J Med Res 3(1-2):95-98.
Hartmann K, Kuffer M, Balzarini J, Naesens L, Goldberg M, Erfle V, Goebel F D, De Clercq E, Jindrich J, Holy A, Bischofberger N, Kraft W (1998) Efficacy of the acyclic nucleoside phosphonates (S)-9-(3-fluoro-2-phosphonylmethoxypropyl)adenine (FPMPA) and 9-(2-phosphonylmethoxyethyl)adenine (PMEA) against feline immunodeficiency virus. J Acquir Immune Defic Syndr Hum Retrovirol 7(2):120-128.
Hofmann-Lehmann R, Cattori V, Tandon R, Boretti F S, Meli M L, Riond B, Pepin A C, Willi B, Ossent P, Lutz H (2007) Vaccination against the feline leukaemia virus: outcome and response categories and long-term follow-up. Vaccine 25(30):5531-5539.
Hosie M J, Addie D, Belak S, Boucraut-Baralon C, Egberink H, Frymus T, Gruffydd-Jones T, Hartmann K, Lloret A, Lutz H, Marsilio F, Pennisi M G, Radford A D, Thiry E, Truyen U and Horzinek M C (2009) Feline immunodeficiency. ABCD guidelines on prevention and management. J Feline Med Surg 11(7):575-584.
Lutz, H. et al. (2009) Feline Leukemia. ABCD guidelines on prevention and management. J Feline Med Surg 11(7); 565-574.
Vahlenkamp T W, De Ronde A, Balzarini J, Naesens L, De Clercq E, Van Eijk M J T, Horzinek M C, Egberink H F (1995) (R)-9-(2-Phosphonylmethoxypropyl)-2,6-Diaminopurine Is a Potent Inhibitor of Feline Immunodeficiency Virus Infection. Antimicrob Agents Chemother 39(3): 746-749.
Yamamoto J K, Hansen H, Ho E W, Morishita T Y, Okuda T, Sawa T R, Nakamura R M, Pedersen N C (1989) Epidemiologic and clinical aspects of feline immunodeficiency virus infection in cats from the continental United States and Canada and possible mode of transmission. J Am Vet Med Assoc 194(2):213-220.

1-25. (canceled)

26. A method for the prevention and treatment of feline leukemia virus infection in a feline in need thereof, comprising the step administering a therapeutically effective amount of a compound of the formula (I): 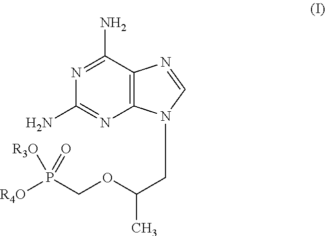
or a solvate, or veterinary acceptable salt thereof,
wherein R₃ and R₄ are hydrogen, or the same or different from each other, CH₂C(O)N(R₅)₂, CH₂C(O)OR₅, CH₂OC(O)R₅, CH(R₅)OC(O)R₅ (R, S, or RS stereochemistry), CH₂C(R₅)₂CH₂OH, or CH₂OR₅;
R₅ is C₁-C₂₀ alkyl, aryl or aryl-alkyl which is unsubstituted or is substituted by hydroxy, oxygen, nitrogen or halogen.

27. The method of claim 26, for increasing the Karnofsky's score modified for cats with at least 10 units in a feline infected with FeLV, compared to the score of said feline prior to treatment.

28. The method of claim 26, for increasing the Karnofsky's score modified for cats with at least 15 units in a feline infected with FeLV, compared to the score of said feline prior to treatment.

29. The method of claim 26, wherein said compound is a stereoisomerically pure compound of the formula (I):

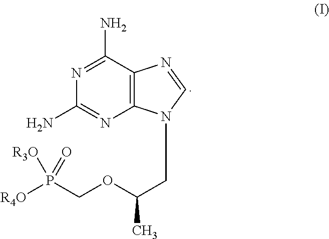

30. The method according to claim 26, wherein said feline is also infected with other retroviruses, such as feline immune deficiency virus.

31. The method of claim 26, wherein said compound is administered to said feline at least 1 time weekly with a total dose of 10-175 mg/kg, during 1 to 6 weeks.

32. The method of claim 26, wherein said compound is administered via subcutaneous injections.

33. The method of claim 26, wherein said feline is suffering from clinical symptoms of FeLV.

34. The method of claim 33, wherein said treatment involves alleviating one or more clinical symptoms of FeLV.

35. The method of claim 33, wherein said clinical symptoms are selected from the group consisting of stomatitis, gingivitis, inflammation of the oral cavity, tumors, diarrhea, neurological symptoms, lethargy, weight loss and lymphadenopathy.

36. A method for the treatment of one or more clinical symptoms selected from the group consisting of loss of body weight, malaise, lethargy, poor coat condition, pyrexia, anemia, concurrent infections, gastroenteritis, gingivitis, neutrophenia, fever, leucopenia, anorexia, neoplasie, stomatitis, gingivostomatitis, rhinitis, diarrhea, chronic or frequent infections of the skin, eyes, urinary tract, respiratory tract, lymphadenopathy, glomerulonephritis, haemorrhagic enteritis, diseases of the nervous system which may cause behavioral changes or seizures, abortion of litters and cancer, in a feline infected with Feline immunodeficiency virus, comprising the step of administering a therapeutically effective amount of a compound of the formula (I), or a solvate, or veterinary acceptable salt thereof, wherein
R₃ and R₄ are hydrogen, or the same or different from each other, CH₂C(O)N(R₅)₂, CH₂C(O)OR₅, CH₂OC(O)R₅, CH(R₅)OC(O)R₅ (R, S, or RS stereochemistry), CH₂C(R₅)₂CH₂OH, or CH₂OR₅;
R₅ is C₁-C₂₀ alkyl, aryl or aryl-alkyl which is unsubstituted or is substituted by hydroxy, oxygen, nitrogen or halogen.

37. The method of claim 36, wherein said compound is a stereoisomerically pure compound of the formula (I):

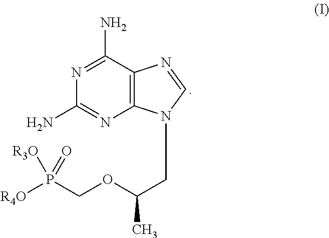

38. The method according to claim 36, for increasing the Karnofsky's score modified for cats with at least 10 units in a feline infected with Feline Immunodeficiency Virus, compared to the score of said feline prior to treatment.

39. The method according to claim 36, wherein said compound is administered to said feline at least 1 time weekly with a total dose of 10-175 mg/kg, during 1 to 6 weeks.

40. The method according to claim 36, wherein said compound is administered via subcutaneous injections.

41. A method for the treatment of one or more symptoms selected from the group consisting of poor appetite, loss of body weight, neutrophenia, fever, leucopenia, anorexia, neoplasie, malaise, apathy, poor coat condition, pyrexia, anemia, concurrent infections, gastroenteritis, gingivitis, stomatitis, gingivostomatitis, rhinitis, diarrhea, chronic or frequent infections of the skin, eyes, urinary tract, respiratory tract, lymphosarcoma, difficult breathing, general inflammation of the oral cavity, diarrhea, lymphadenopathy, pale mucous membranes, gastrointestinal disorders, glomerulonephritis, haemorrhagic enteritis, diseases of the nervous system which may cause behavioral changes or seizures, abortion of litters, tumours and cancer, in a feline infected with Feline immunodeficiency virus or Feline leukemia virus,
comprising the step administering a therapeutically effective amount of a compound of formula (I) or a solvate, or veterinary acceptable salt thereof,
wherein,
R₃ and R₄ are hydrogen, or the same or different from each other, CH₂C(O)N(R₅)₂, CH₂C(O)OR₅, CH₂OC(O)R₅, CH(R₅)OC(O)R₅ (R, S, or RS stereochemistry), CH₂C(R₅)₂CH₂OH, or CH₂OR₅;
R₅ is C₁-C₂₀ alkyl, aryl or aryl-alkyl which is unsubstituted or is substituted by hydroxy, oxygen, nitrogen or halogen.

42. The method of claim 41, wherein said compound is administered to said feline at least 1 time weekly with a total dose of 10-175 mg/kg, during 1 to 6 weeks.

43. The method of claim 41, wherein said compound is administered via subcutaneous injections.

44. The method of claim 41, wherein said feline is infected with Feline immunodeficiency virus and Feline leukemia virus.
